(19) United States
(12) Patent Application Publication
(10) Pub. No.: US 2013/0013088 A1
(43) Pub. Date: Jan. 10, 2013

(54) MANAGEMENT FRAMEWORK AND METHOD FOR RETRIEVING SOFTWARE IDENTIFICATION INFORMATION PERTAINING TO A SENSOR IN A NETWORK

(75) Inventors: Werner Liekens, Sint Katelijne Waver (BE); Bruno Van Bogaert, Schaarbeek (BE); Tom Van Leeuwen, Wondelgem (BE); Pascal Justen, Sint-Pieters-Woluwe (BE); Willem Jozef Amaat Acke, Bonheiden (BE)

(73) Assignee: ALCATEL LUCENT, Paris (FR)

(21) Appl. No.: 13/504,320

(22) PCT Filed: Nov. 23, 2010
(86) PCT No.: PCT/EP10/67993

§ 371 Date: Jul. 30, 2012

(30) Foreign Application Priority Data
Nov. 26, 2009 (EP) 09306144.8

(51) Int. Cl. G06F 17/00

(52) U.S. Cl. 700/90

(57) ABSTRACT

The invention concerns using sensorML to facilitate the installation of software for interaction with sensors, preferably within a home network with a service gateway (100). According to the invention, a management framework (130) is provided to manage a sensor controlling means, adapted to transmit management instructions to said sensor controlling means, and to receive information in sensorML format, wherein the information comprises software identification information. According to another aspect of the invention, a method is provided for retrieving software identification information pertaining to a sensor in a network, comprising accessing a sensorML document (400), and extracting software identification information from it.

### FIELD

The present invention pertains to the field of networked sensors, more particularly the field of controlling networked sensors in a residential network.

### BACKGROUND

Networked sensors of various kinds are becoming more pervasive in daily life, including in residential settings, where they can be part of the home automation or domotics infrastructure.

### SUMMARY OF THE INVENTION

Where sensors have been integrated in a network, it can be advantageous to make them accessible to potential data customers by advertising the sensors' presence and capabilities in some standardized way. SensorML is a mark-up language that was designed to allow such standardized advertisements and descriptions of networked sensors, as a means to enable third-party usage of these sensors.

Markup languages are well known. The eXtensible Markup Language (XML) is a widely used standard for such markup languages, ensuring a maximum degree of interoperability among systems designed to handle information in the form of XML documents. SensorML is a particular XML dialect intended for the description of the characteristics of sensors, and data acquired by sensors. The sensorML language was developed in the context of global research programs, including highly sophisticated satellite-based and earth-based sensors, wherein a reuse of the obtained data by multiple organizations improves the scientific return of the equipment investment.

Where sensors are being integrated in a home network, for instance as part of a home automation system, it is generally not desirable to give third parties indiscriminate access to the data obtained or processes controlled by these sensors.

Embodiments of the invention are based on the insight that it may nevertheless be advantageous to provide directed advertisements of the presence and capabilities of the different sensors in the home to a centralized system that is adapted to provide services using the sensors' data and processes. Such a centralized system may be present in the home or in a service provider's premises.

A problem with providing services based on sensors present in the home network is the fact that the availability of sensors may vary over time, especially as sensors are being added to the home network. A particular problem is that there typically may not be appropriate software or firmware installed to correctly interact with newly installed sensors.

The present invention pertains to the provision of services on the basis of networked sensors, and to the use of sensorML for directing network elements towards software enabling interaction with networked sensors.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 represents a first network lay-out including the management framework according to the invention;

FIG. 2 represents a second network lay-out including the management framework according to the invention; and

FIG. 3 shows a flow chart of a method according to the invention.

### DESCRIPTION OF EMBODIMENTS

To optimize the communication streams between the centralized system and the networked sensors, it is advantageous to provide a sensor abstraction layer, capable of translating the raw readings of the sensors into well-defined events that can be used by application programmers. It is further advantageous to provide a protocol layer, capable of detecting the addition and/or removal of sensors to and from the network. A management framework is provided to configure and update the sensor abstraction layer and/or the protocol layer.

It is advantageous to provide accessibility to the sensors through a residential gateway, such as those according to the standards issued by the OSGi Alliance. Such residential gateways comprise a Java-based service platform that can be remotely managed. The OSGi framework provides an application life cycle management model, a service registry, an execution environment, and modules. Based on this framework, a large number of OSGi layers, APIs, and services have been defined.

Preferably, the protocol layer is implemented on the OSGi framework and consists out of a number of software bundles.

Optionally, the sensor abstraction layer is also implemented on the OSGi framework, although it may also be part of the service provider infrastructure. Preferably, the sensor abstraction layer and the protocol layer exchange information using the Internet Protocol (IP). This ensures that similar communication means may be used, regardless of whether the sensor abstraction layer and the protocol layer are provided within the same physical platform or not.

The management framework preferably communicates with the sensor abstraction layer and the protocol layer using a management and configuration protocol such as TR-069.

In a system according to the invention, the management framework further communicates with a database comprising various information about different types of sensors, under the form of sensorML documents. The management framework is adapted to extract relevant information from these sensorML documents.

According to an aspect of the invention, there is provided a management framework for use in a system comprising a sensor controlling means for controlling at least one sensor, said management framework comprising means to generate and transmit management instructions to the sensor controlling means, and means to receive and parse information formatted according to a sensorML format, wherein said information comprises software identification information. In one embodiment, the software identification information pertains to firmware for the at least one sensor. In another embodiment, the sensor controlling means comprises a sensor abstraction layer, and the software identification information pertains to software to be run in the software abstraction layer. In yet another embodiment, the sensor controlling means comprises a protocol layer, and the software identification information pertains to software to be run in the protocol layer.

The software to be run in the sensor abstraction layer or the protocol layer is preferably comprised of bundles to be installed in the respective layers, for instance for the purpose of ensuring correct interoperation with the specific sensor.

In an embodiment of the management framework of the present invention, the software identification information comprises a uniform resource locator (URL). In another embodiment, the software identification information comprises a version identifier.

In an embodiment of the management framework of the present invention, the management instructions are formatted according to a TR-069 format.

In an embodiment, the management framework of the present invention is comprised in a service gateway.

According to another aspect of the invention, there is provided a method for identifying software for interacting with a sensor in a network, said method comprising using a sensorML document containing software identification information pertaining to a number of sensor types, said sensor belonging to a sensor type among said number of sensor types.

In an embodiment, the method of the present invention further comprises accessing the sensorML document and extracting the software identification information pertaining to the sensor from the sensorML document.

In an embodiment of the method of the present invention, the sensorML document is stored among a plurality of sensorML documents, and the method further comprises detecting attachment of the sensor to the network and determining a type identifier of the sensor, using the type identifier to select the sensorML document from among the plurality of sensorML documents.

In an embodiment, the method according to the present invention further comprises installing software identified by the software identification information.

In an embodiment of the method of the invention, the software identification information pertains to firmware for the sensor.

In an embodiment of the method of the invention, the software identification information comprises a uniform resource locator (URL). In another embodiment, the software identification information comprises a version identifier.

In an embodiment of the method according to the present invention, the network is a residential network comprising a service gateway, and the extracting is performed by the service gateway.

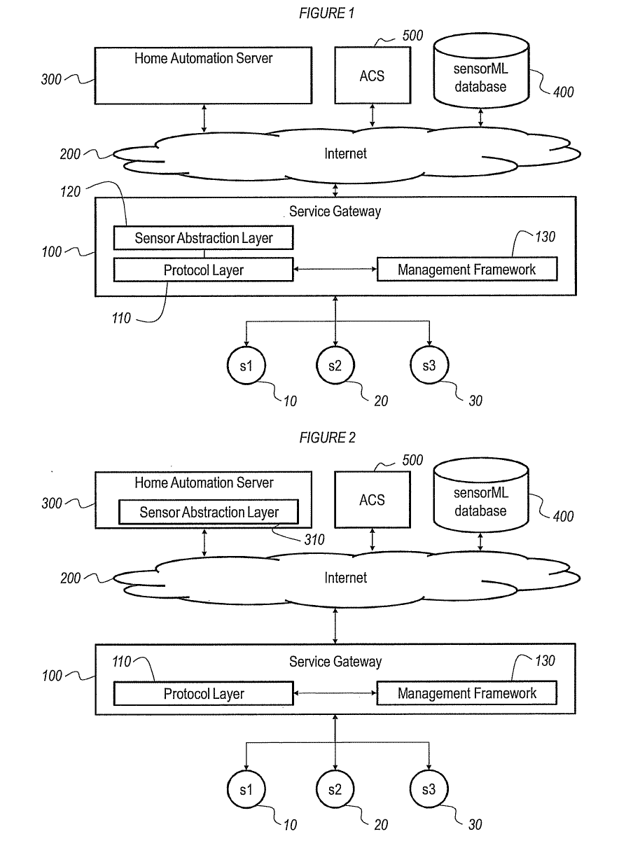

FIGS. 1 and 2 represent network layouts for providing sensor-based home automation services from a server 300 outside the home network, via a service gateway 100. Service gateway 100 controls and/or reads sensors 10, 20, 30 present in the home network.

Although three sensors are shown in the figures, this does not imply any intention to limit the invention to cases where there are three sensors present. Any number of sensors may be present. Such sensors may include web cameras, motion sensors, light sensors, temperature sensors, and controllers for light, heating appliances, motors and the likes.

Sensors 10, 20, 30 may include drivers (not shown) to allow the different software components of service gateway 100 to interact with the hardware of the respective sensors.

Optionally, the service gateway 100 may associate IP addresses to the sensors 10, 20, 30, and provide translation functions to translate messages from and to sensors 10, 20, 30, if necessary, between their respective native communication protocols and the internet protocol, thus allowing virtually direct, proxy-based interaction between legacy sensors and the IP network.

Service gateway 100 comprises a protocol layer 110 for detecting the addition and/or removal of sensors to the home network.

Service gateway 100 also comprises a management framework 130, for managing the functions of the service gateway 100 and receiving status messages from these functions, including the protocol layer 110.

Service gateway 100 is preferably a gateway according to the OSGi specifications. More specifically, service gateway 100 is preferably a software platform based on JAVA technology, in which protocol layer 110 and management framework 130 are implemented as one or more software bundles. The service gateway 100 provides a demarcation between the home network and a service provider network infrastructure, wherein the home network includes the sensors 10, 20, 30, and the service provider network infrastructure is preferably part of or interconnected with the internet 200.

The embodiments of the invention described below involve interaction with a source of sensorML descriptions for various kinds of sensors, represented in FIGS. 1 and 2 as the sensorML database 400. The sensorML descriptions provided by database 400, according to the invention, include information about the software that is required in a service gateway 100 to adequately interact with sensors of the kind described. Optionally, the sensorML descriptions according to the invention include information about firmware to be loaded into the sensors of the kind described, to ensure optimal use of the sensors' functionality. The information about software and/or firmware may consist of a Uniform Resource Identifier (URI) or Uniform Resource Locator (URL) pointing towards a web-accessible location where the software and/or firmware may be obtained.

The management framework 130 is adapted to generate the necessary management instructions to configure and manage the entities under its control, and to convey these instructions to the controlled entities via an internal interface and/or the network. The management framework 130 according to the invention is adapted to extract the information about software and/or firmware from the sensorML data supplied by the sensorML database 400, in particular by receiving the document over the network and/or an internal interface, and by parsing it according to the sensorML document structure. The management framework 130 according to the invention may be further adapted to install the firmware and the software referred to in said information onto the service gateway 100.

According to the embodiment shown in FIG. 1, a home automation server 300 is provided to deliver services related to home automation from outside the home network. The home automation server accesses the sensors 10, 20, 30 via the service gateway 100. Preferably, the home automation server 300 implements services in software by using an application programming interface (API) exposed by a sensor abstraction layer 120 comprised in the service gateway 100, communication with which is conducted by means of the internet protocol. The sensor abstraction layer 120 preferably communicates with other components of the service gateway 100 by means of the internet protocol.

If a sensor is added, protocol layer 110 is responsible for detecting an addition of a sensor to the home network. Upon such detection, protocol layer 110 will notify management framework 130 of this event. Such a notification contains an identifier representative of the type of sensor that was added. According to the invention, the management framework 130 will verify whether the necessary software is present at the level of the service gateway 100, and more specifically the service abstraction layer 110, to adequately interact with the added sensor. To this end, management framework 130 accesses a sensorML database 400, which contains sensorML descriptions of a plurality of sensor types. The access to this database 400 may be provided by a web server or database server of the well-known kinds. The communication between the management framework 130 and the sensorML database 400 may be established through an auto-configuration server (ACS) 500. The appropriate sensorML description is selected on the basis of the identifier of the sensor.

Preferably, the protocol layer 110 further notifies the home automation server 300 of the addition event. Such a notification contains an identifier representative of the type of sensor that was added. The home automation server 300 may be adapted to contact the sensorML server 400 to obtain information about the capabilities of the added sensor, using the identifier to select the correct sensorML description.

According to the embodiment shown in FIG. 2, the home automation server 300 may alternatively incorporate a sensor abstraction layer 310. The sensor abstraction layer preferably communicates with the components of the service gateway 100 by means of the internet protocol, for instance by using TR-069 messaging over IP. The home automation server 300 accesses the sensors 10, 20, 30 via the service gateway 100.

If a sensor is added, protocol layer 110 is responsible for detecting an addition of a sensor to the home network. Upon such detection, protocol layer 110 will notify management framework 130 of this event. Such a notification contains an identifier representative of the type of sensor that was added. According to the invention, the management framework 130 will verify whether the necessary software is present at the level of the service gateway 100 to adequately interact with the added sensor. To this end, management framework 130 accesses a sensorML database 400, which contains sensorML descriptions of a plurality of sensor types. The access to this database 400 may be provided by a web server or database server of the well-known kinds. The communication between the management framework 130 and the sensorML database 400 may be established through an auto-configuration server (ACS) 500. The appropriate sensorML description is selected on the basis of the identifier of the sensor.

Upon notification by the protocol layer 110 of an addition of a sensor, optionally via the management framework 130 and/or the auto-configuration server (ACS) 500, the home automation server 300 may additionally contact sensorML database 400 to obtain information about software required for optimal interaction with the added sensor.

The skilled person will understand that the network elements appearing the figures also comprise the typical components required for communicating over a network, preferably an IP network. Although these elements are not shown in the figures, it shall be understood that the network elements rely on these components to transmit and receive the respective messages required for their operation according to the present invention.

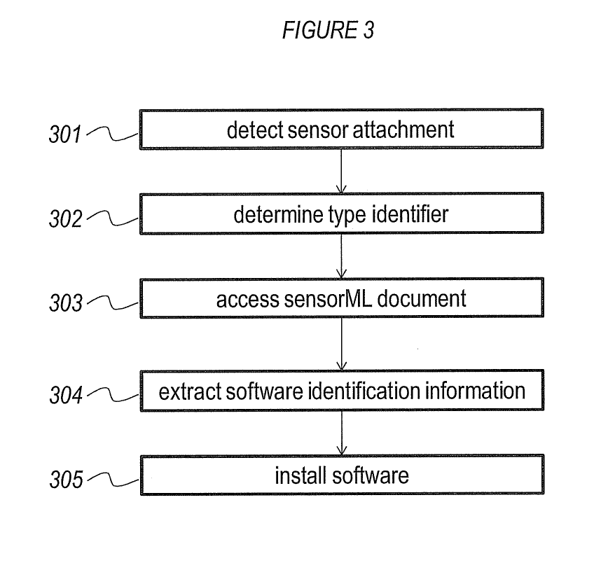

FIG. 3 presents a flow chart of a method according to the present invention, the steps of which will now be described.

In a first or preliminary step 301, the attachment of a sensor to the network is detected. Attachment signifies a connection on at least the physical level, allowing a minimal flow of information between the sensor and the network, including such information as may be necessary to allow the detection of the sensor's presence on the network. Attachment may also comprise the setting up of a connection at the data link layer and/or higher layers of the protocol stack.

The type of the attached sensor is determined and stored for further use as a type identifier 302, preferably by receiving a message comprising the type identifier from the attached sensor.

Where the sensor network is part of a residential network comprising a service gateway 100, attachment detection 301 preferably takes place at a protocol layer 110 comprised in the service gateway 100.

A sensorML document, available at a predetermined document store, such as a web server, an internal volatile or non-volatile memory, a disk drive, or similar, is accessed 303 to obtain information about the attached sensor. Software identification information pertaining to the attached sensor is extracted 304 from the sensorML document.

When a service gateway 100 is used, the accessing 303 may be performed by a management framework 130, comprised in the service gateway 100. However, the accessing 303 may likewise be performed by an auto-configuration server 500 in communication with the service gateway 100.

In an embodiment, the type identifier of step 302 is used to select the sensorML document to be accessed. In another embodiment, the type identifier of step 302 is used to select the appropriate information structures for the attached sensor within a common sensorML document.

The software identification information preferably comprises information about software required for optimal interaction with the attached sensor 10, 20, 30. In an embodiment, the software identification information pertains to firmware for the attached sensor 10, 20, 30. In another embodiment, the software identification information pertains to software to be run in a service gateway 100, preferably at the level of the protocol layer 110 or the sensor abstraction layer 120.

The software identification information may comprise a Uniform Resource Identifier (URI) or Uniform Resource Locator (URL) of a network resource providing the software, and it may comprise information about the preferred version of the relevant software to be installed.

If relevant software as identified by the software identification information has been obtained, the software is installed 305 onto the target platform, such as the service gateway 100 or the attached sensor 10, 20, 30.

Although the steps of the method according to the invention have been described in the order in which they appear in FIG. 3, the order of the steps is not essential unless where it is apparent from the description that a particular step cannot take place until another step has been completed.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

1. A management framework for use in a system comprising a sensor controlling means for controlling at least one sensor, said management framework comprising means to generate and transmit management instructions to said sensor controlling means, and means to receive and parse information formatted according to a sensorML format, wherein said information comprises software identification information.

2. The management framework according to claim 1, wherein said software identification information pertains to firmware for said at least one sensor.

3. The management framework according to claim 1, wherein said sensor controlling means comprises a sensor abstraction layer, and wherein said software identification information pertains to software to be run in said sensor abstraction layer.

4. The management framework according to claim 1, wherein said sensor controlling means comprises a protocol layer, and wherein said software identification information pertains to software to be run in said protocol layer.

5. The sensor according to claim 1, wherein said software identification information comprises a uniform resource locator (URL).

6. The sensor according to claim 1, wherein said software identification information comprises a version identifier.

7. The sensor according to claim 1, wherein said management instructions are formatted according to a TR-069 format.

8. A service gateway comprising the management framework according to claim 1.

9. A method for identifying software for interacting with a sensor in a network, said method comprising using a sensorML document containing software identification information pertaining to a number of sensor types, said sensor belonging to a sensor type among said number of sensor types.

10. The method according to claim 9, further comprising:
accessing said sensorML document; and
extracting said software identification information pertaining to said sensor from said sensorML document.

11. The method according to claim 10, wherein said sensorML document is stored among a plurality of sensorML documents, said method further comprising:
detecting attachment of said sensor to said network; and
determining a type identifier of said sensor;
using said type identifier to select said sensorML document from among said plurality of sensorML documents.

12. The method according to claim 9, further comprising:
installing software identified by said software identification information.

13. The method of claim 9, wherein said software identification information pertains to firmware for said sensor.

14. The method of claim 9, wherein said software identification information comprises a uniform resource locator (URL).

15. The method of claim 10, wherein said network is a residential network comprising a service gateway, and wherein said extracting is performed by said service gateway.
